(19) United States
(12) Patent Application Publication
(10) Pub. No.: US 2023/0138763 A1
(43) Pub. Date: May 4, 2023

(54) SYSTEMS AND METHODS FOR MODULAR SYNTACTIC GENERATORS FOR SYNTHETIC DATA GENERATION

(71) Applicant: Capital One Services, LLC, McLean, VA (US)

(72) Inventors: Austin WALTERS, Savoy, IL (US); Jeremy GOODSITT, Champaign, IL (US); Anh TRUONG, Champaign, IL (US); Galen RAFFERTY, Mahomet, IL (US)

(73) Assignee: Capital One Services, LLC, McLean, VA (US)

(21) Appl. No.: 17/452,959

(22) Filed: Oct. 29, 2021

(51) Int. Cl. G06K 9/62; G06F 40/263

(52) U.S. Cl. CPC G06K 9/6257; G06K 9/627; G06F 40/263; G06K 9/6265

(57) ABSTRACT

Systems and methods for modular generators for synthetic data generation are disclosed. The disclosed systems and methods may include a system for generating synthetic data that may comprise at least one processor configured to execute instructions to perform operations. The operations may include receiving a request for synthetic data, selecting a syntax generator, generating, using the syntax generator, a token set comprising a first token and a second token, and identifying a first token type corresponding to the first token and a second token type corresponding to the second token. Operations may further include selecting first and second content generators; generating, using the first content generator, first content data, generating, using the second generator, second content data and generating a synthetic data set by replacing, in the token set, the first token with the first content data and the second token with the second content data.

### TECHNICAL FIELD

The disclosed embodiments concern creating modular data models. These data models can be used to generate synthetic data for testing or training artificial intelligence systems, for example.

### BACKGROUND

Training artificial intelligence systems may require substantial amounts of training data. Different artificial intelligence systems with different goals may also require unique types of synthetic data in varying formats, for example, emails, documents, names, addresses, account numbers, or others. Furthermore, when used with data dissimilar from the training data, artificial intelligence systems may perform poorly. Proper training may require a large amount of training data to cover a variety of scenarios. In addition, training data may include sensitive portions (e.g., confidential information), the storage, transmission, and distribution of which may be regulated, making these data unavailable for training or imposing strict and cumbersome data processing requirements to protect sensitive data portions.

Existing approaches to generating synthetic data employing single unified models may be specific to a certain problem domain. As an example, a model may only generate emails in the English language. Another model may only be able to generate sentences in a certain dialect of Spanish. Yet another model may only generate synthetic addresses in the format of a certain country. However, existing methods of creating synthetic data can be extremely slow and resource-intensive. Utilizing problem domain-specific models requires a new model to be trained for each new problem faced. However, training a new model requires new training data, dedication of computing resources, and additional time expenditure. Accordingly, a need exists for systems and methods of creating synthetic data similar to existing datasets that can be used across varying problem domains.

### SUMMARY

The disclosed embodiments describe systems and methods for generating synthetic data using modular generators. For example, in an exemplary embodiment, there may be a system for generating synthetic data. The system may include at least one memory storing instructions; and at least one processor configured to execute the instructions to perform operations. The operations may include receiving a request for synthetic data, the request indicating a synthetic data format. The operations may include selecting first syntax generator based on the synthetic data format and generating a token set comprising a first token and a second token using the first syntax generator. The operations may include identifying a first token type corresponding to the first token and a second token type corresponding to the second token and selecting, from a plurality of content generators, a first content generator associated with the first token type and a second content generator associated with the second token type. The operations may include generating, using the first content generator, first content data, and generating, using the second generator, second content data. The operations may include generating a first synthetic data set by replacing, in the token set, the first token with the first content data and the second token with the second content data.

According to a disclosed embodiment, selecting the first content generator may be based on a criterion.

According to a disclosed embodiment, selecting the first content generator may be based on the synthetic data format.

According to a disclosed embodiment, selecting the first content generator may be based on a language criterion.

According to a disclosed embodiment, selecting the first one of the syntax generators may be further based on a language criterion.

According to a disclosed embodiment, the synthetic data format may be a text-based format.

According to a disclosed embodiment, the synthetic data format may be an image format.

According to a disclosed embodiment, the operations may further comprise calculating a similarity metric reflecting a measure of similarity between the synthetic data and reference data and retraining, based on the similarity metric and a threshold, at least one of the first content generator or second content generator.

According to a disclosed embodiment, the operations may further comprise generating, based on the retrained content generator, a second set of synthetic data.

According to a disclosed embodiment, the synthetic data format may be an audio format.

According to another disclosed embodiment, a method may be implemented for generating synthetic data. The method may include receiving a request for synthetic data indicating a synthetic data format and selecting a syntax generator based on the synthetic data format. The method may include generating a token set comprising a first token and a second token using the first syntax generator and identifying a first token type corresponding to the first token and a second token type corresponding to the second token. The method may include selecting, from a plurality of content generators, a first content generator corresponding to the first token type and a second content generator corresponding to the second token type. The method may include generating first content data corresponding to the first token using the first content generator, and generating second content data corresponding to the second token using the second generator. The method may include generating synthetic data by replacing, in the token set, the first token with the first content data and the second token with the second content data.

According to a disclosed embodiment, the first token type may be different from the second token type.

According to a disclosed embodiment, the synthetic data format may be a document type.

According to a disclosed embodiment, the synthetic data format may be a video format.

According to a disclosed embodiment, the method may further include generating, using the first content generator, first content data corresponding to the first token; generating, using the second generator, second content data corresponding to the second token; and generating synthetic data by replacing, in the token set, the first token with the first content data and the second token with the second content data.

According to a disclosed embodiment, the method may further include training, using the plurality of generated synthetic data records as training data, a machine learning model.

According to a disclosed embodiment, the method may further include receiving a second request for synthetic data, the request indicating a second synthetic data format different from the first synthetic data format and selecting a second syntax generator based on the second synthetic data format. The second syntax generator may be different from the first syntax generator. The method may further include generating, using the second syntax generator, a second token set different from the first token set and comprising the first token and the second token. The method may further include generating a second synthetic data set by replacing, in the second token set, the first token with the first content data and the second token with the second content data.

According to a disclosed embodiment, the second token set may further include a third token having a third token type.

According to a disclosed embodiment, the method may further include selecting a third content generator associated with the third token type from the plurality of content generators and generating third content data using the third content generator. Generating the second synthetic data set may further include replacing the third token with the third content data.

According to another disclosed embodiment, a method may be implemented for generating synthetic data. The method may include receiving a request for synthetic data indicating a synthetic data format and identifying a set of training data having the synthetic data format. The method may include training a syntax generator to generate a plurality of tokens corresponding to the synthetic data format using the training data and generating a token set comprising a first token and a second token using the syntax generator. The method may include identifying a first token type corresponding to the first token and a second token type corresponding to the second token and selecting, from a plurality of content generators, a first content generator corresponding to the first token type and a second content generator corresponding to the second token type. The method may include generating first content data corresponding to the first token using the first content generator and generating second content data corresponding to the second token using the second generator. The method may include generating synthetic data by replacing, in the token set, the first token with the first content data and the second token with the second content data and calculating a similarity metric of the synthetic data by comparing the synthetic data to reference data. The method may include determining that the similarity metric does not exceed a similarity threshold and retraining the syntax generator based on the determination.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate several embodiments and, together with the description, serve to explain the principles of the disclosure. The drawings are not necessarily to scale or exhaustive. In the drawings:

FIG. 1 is an exemplary computing environment for generating synthetic data, consistent with disclosed embodiments.

FIG. 2 is an illustration depicting an exemplary synthetic data syntax, consistent with disclosed embodiments.

FIG. 3 is a block diagram depicting an exemplary process for generating synthetic data using a modular syntactic generator, consistent with disclosed embodiments.

FIG. 4 is a flowchart depicting an exemplary process for generating synthetic data using a modular syntactic generator, consistent with disclosed embodiments.

FIG. 5 is a flowchart depicting an exemplary process for provisioning modular generators, consistent with disclosed embodiments.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Numerous specific details are set forth in order to provide a thorough understanding of the disclosed example embodiments. Unless otherwise defined, technical and/or scientific terms have the meaning commonly understood by one of ordinary skill in the art. The disclosed embodiments are described in sufficient detail to enable those skilled in the art to practice the disclosed embodiments.

However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence, or constrained to a particular system configuration. Additionally, some of the described embodiments or elements thereof can occur or be performed simultaneously, at the same point in time, or concurrently. For example, unless otherwise indicated, method steps disclosed in the figures can be rearranged, combined, or divided without departing from the envisioned embodiments. Similarly, additional steps may be added or steps may be removed without departing from the envisioned embodiments. For example, according to some embodiments, parts of processes 300, 400, and 500 in the following description may be combined (e.g., one or more steps from process 500 may be added to process 400).

Machine learning and artificial intelligence models often require large amounts of data for accurate and robust training and testing. In many cases, it may not be feasible or cost-efficient to use real data for such training purposes. Real data may also include sensitive data and thus present security risks. Instead of real data, synthetic data may be used to train and test models. This synthetic data can be generated using a synthetic dataset model, which can in turn be generated using an initial actual reference dataset.

Different models may require significantly different types of synthetic data for training purposes. Thus, for each new machine learning model needing to be trained, a separate model would need to be created for generating synthetic data to train the machine learning model. Creating a model to generate synthetic data accurately is time-consuming, costly, and computationally expensive. Disclosed embodiments implement a modular approach to synthetic data models to reduce costs, save time, and provide increased stability over conventional approaches.

According to disclosed embodiments, a modular data generation system may include syntax generators and content generators. Syntax generators and content generators may be used together to generate synthetic data sets having a particular format. A syntax generator may be used to generate syntax (i.e., a token set) corresponding to a particular form of synthetic data (e.g., an email, document, image, etc.). One or more content generators may then be used to generate data content (i.e., specific words, phrases, numbers, or other information) that corresponds to the various tokens within the token set. These pieces of data content may be used to fill in different instances of particular tokens in a token set, thus creating synthetic data. Syntax generators and content generators may be modularly interchanged. In some embodiments, the same content generators may be used to create content for multiple different contexts associated with different syntax generators. For example, the same address content generator may be used with both an email syntax generator and a contract syntax generator to generate a synthetic address for placement within the email or contract.

As described in greater detail below, disclosed embodiments may decrease the time, resources, and costs associated with generating synthetic data sets. The synthetic data may be similar to the actual data in terms of values, value distributions (e.g., univariate and multivariate statistics of the synthetic data may be similar to that of the actual data), structure and ordering, or the like. In this manner, the data model for the machine learning application can be generated without directly using the actual data. By using modular generators dedicated to syntax and content, for example, generators may be used across multiple problem domains, increasing efficiencies when generating synthetic data having different formats. Additionally, for new types of synthetic datasets needed, a smaller syntax model may be generated and then combined with existing content generators. Thus, disclosed embodiments may also increase the security and privacy related to sensitive data sets or data formats. For example, a user could send a syntax generator trained to generate a certain sensitive data format to a second user for implementation. The second user could implement the syntax generator in concert with content generators and thereby create synthetic data related to the sensitive data without ever having access to the sensitive data.

Reference will now be made in detail to the disclosed embodiments, examples of which are illustrated in the accompanying drawings.

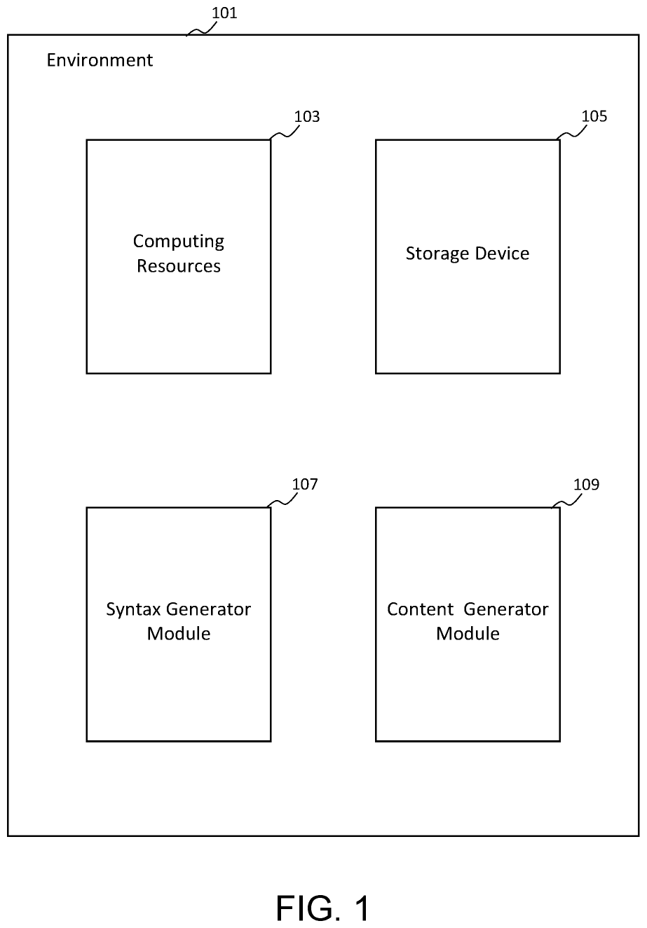

FIG. 1 is an exemplary computing environment 101 for implementing modular generators, consistent with disclosed embodiments. Environment 101 can be configured to support generation and storage of synthetic data, as well as generation and storage of modular data models. Environment 101 can be configured to expose an interface for communication with other systems. Environment 101 can include computing resources 103, a storage device 105, a syntax generator module 107, and a content generator module 109, as shown in FIG. 1. The particular arrangement of components depicted in FIG. 1 is not intended to be limiting. Environment 101 can include additional components, or fewer components. Multiple components of environment 101 can be implemented using the same physical computing device or different physical computing devices.

Components of environment 101 can be configured to communicate with each other, or with external components of environment 101, using a network. A network can facilitate communications between the other components of environment 101. The network can include one or more networks, including a TCP/IP network (e.g., the Internet), a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications network (e.g., a Bluetooth link, an infrared link, etc.), or another type of communications network. The disclosed embodiments are not limited to embodiments in which communications between components of environment 100 occur over a particular type of network. Furthermore, the disclosed embodiments are not limited to communication through a network. In some embodiments, components of environment 100 may additionally or alternatively communicate between each other directly.

Computing resources 103 can include one or more computing devices configurable to train modular data models and execute modular data models to generate synthetic data. Computing resources 103 can be general-purpose computing devices such as a personal computer (e.g., a desktop, laptop, workstation, or the like); server, a cloud computing environment or a virtual machine (e.g., virtualized computer, container instance, etc.). Consistent with disclosed embodiments, computing resources 103 can be special-purpose computing devices, such as graphical processing units (GPUs), application-specific integrated circuits, a network appliance, or the like. In some embodiments, computing resources 103 may include cloud computing instances (e.g., one or more AMAZON LAMBDA instances or other containerized instances). Consistent with disclosed embodiments, computing resources 103 can be configured to host an environment for training data models. For example, the computing devices can host virtual machines, pods, or containers.

Computing resources 103 can be configured to run applications for generating data models. For example, the computing devices can be configured to run SAGEMAKER, GENESYS, or similar machine learning training applications. Computing resources 103 can be configured to receive models for training or execution from storage device 105, syntax generator module 107, content generator module 109, or another component of environment 101. Computing resources 103 can be configured to provide training results, including trained models and model information, such as the type or purpose of the model and any measures of classification error. Computing resources 103 can also be configured to provide results of model execution, for example, token sets or synthetic data sets generated by models.

In some embodiments, computing resources 103 may also include one or more client devices. Client devices may for example, be used to request or access synthetic data of a certain format. Client devices may also provide an interface for interacting with environment 101.

Consistent with disclosed embodiments, computing resources 103 may comprise one or more processors and one or more memories. A processor (or processors) can be one or more data or software processing devices. For example, the processor may take the form of, but is not limited to, a microprocessor, embedded processor, or the like, or may be integrated in a system on a chip (SoC). Furthermore, according to some embodiments, the processor may be a processor manufactured by Intel®, AMD®, Qualcomm®, Apple®, NVIDIA®, or the like. A processor may also be based on the ARM architecture, a mobile processor, or a graphics processing unit, etc. The disclosed embodiments are not limited to any type of processor configured in the computing resources 103. Additionally, the processor may in some embodiments execute one or more programs (or portions thereof) remotely located from the particular computing resource.

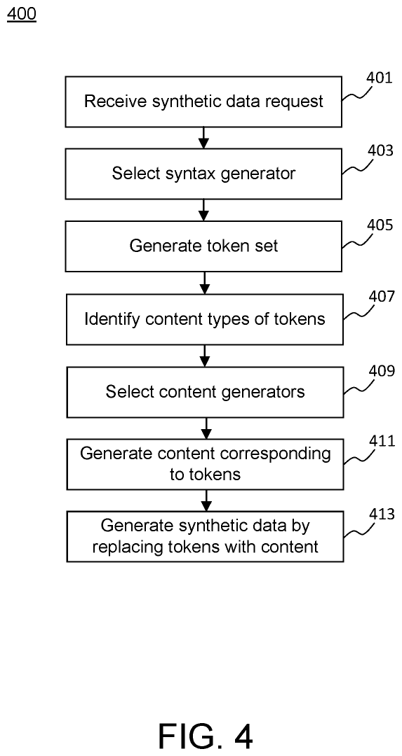

A memory (or memories) may include one or more storage devices configured to store instructions used by the processor to perform functions related to disclosed embodiments. Memory may be configured to store software instructions, such as programs, that when executed by processor, perform one or more operations consistent with disclosed embodiments. The disclosed embodiments are not limited to particular software programs or devices configured to perform dedicated tasks. For example, a memory may store a single program, such as a user-level application, or may store multiple software programs. For example, a memory may include a program for generating synthetic data, e.g., executing process 400 illustrated in FIG. 4. As another non-limiting example, a memory may store an application that may provide an interface for a user, which may facilitate access to one or more parts of environment 101. A memory may also be configured to store data associated for use by a program or data entered by a user in accordance with disclosed embodiments. In some embodiments, a memory may also include an operating system (e.g., a Windows™ operating system, Apple™ operating system, Android™ operating system, Linux operating system, a cloud-based operating system, or other types of operating systems).

As depicted in FIG. 1, environment 101 may include one or more storage devices 105. Storage device 105 can be a database, storage service, include one or more databases configured to store data for use by system 100. As an example, storage device 105 may include one or more cloud-based databases (e.g., AMAZON WEB SERVICES S3 buckets) or on-premises databases. In some embodiments, storage device 105 may be local memory or other storage local to one or more of computing resources 103. Storage device 105 can be configured to store information about data models, such as syntax generators and content generators. For example, storage device 105 may store data indicating a specific syntax generator corresponding to a certain data format. Similarly, storage device 105 may store data indicating a particular type of content or a token type corresponding to a certain content generator. In some embodiments, storage device 105 can be configured to generate synthetic datasets. Storage device 105 may be configured to provide information regarding data models to a user, another system, or another component of environment 101.

Environment 101 may also include a syntax generator module 107. Syntax generator module 107 may be a storage device configured to store one or more syntax generators. Syntax generator module 107 may also store information related to various syntax generators, for example, indicating a type of syntax or data corresponding to a particular syntax generator. As used herein, a syntax generator is a data model configured to generate syntax for synthetic data. Syntax for synthetic data includes, but is not limited to, format or structure of synthetic data according to one or more rules. For example, syntax of synthetic data may be in the form of a sentence or phrase. As another example, syntax of synthetic data may be a particular type of document or communications, such as a contract, patent, email, letter, text message, or others. The syntax may indicate for example, the types of words or information included in the sentence, phrase, document, communication, etc. For example, the syntax may include indications of different parts of speech, names, addresses, numbers, colors, images, sounds, or other suitable information. Rules may indicate, for example, grammatical standards of a certain language or standards of etiquette or formatting associated with a document or communication.

Syntax is not limited to text-based syntax. In some embodiments, syntax may take the form of visual or auditory syntax. For example, syntax could indicate colors or pixels within an image for video, such as a series of pixels of a certain RGB color range, saturation, brightness, etc. within an area of an image. As another example, syntax may also indicate organization according to rules of certain sounds, pitches, notes, or sound magnitudes.

As described herein, the syntax may take the form of a set of tokens. Tokens may be variables generated to represent a particular type of information. For example, a certain token may represent an address, while another token may represent an image, and a third token represents a name. The makeup of a particular token set and the information to which the tokens correspond may indicate the type of syntax the tokens represent. Syntax generator module 107 may store information related to each syntax generator, for example, information indicating token types or content data types that correspond to the token sets produced by the syntax generator. The information indicating token types may map a certain token to a type of content, such as a certain type of words, number, or other information, as described herein.

A syntax generator may be associated with one or more properties of the synthetic data that it is configured to produce. For example, a property of the synthetic data may include a format or type of data, a language or dialect, an indication of realism of the synthetic data, a sophistication level of the synthetic data, a character set or encoding, sentiment (e.g., a level or indication of attitude or emotion), type of data source (e.g., an email, a text message, a voicemail or transcript, a post or thread from a forum such as Reddit™, or others), or other suitable characteristic of the synthetic data. Syntax generators may also be associated with model properties or attributes, such as a type of the model, a speed of the model, etc. In some embodiments, such properties may be expressed in the form of a score, relative level, or number. As an example, the speed of a syntax generator may be expressed in the form of a relative score on a scale of 1-10. As another example, syntax generators may be assigned a relative speed level, such as “low,” “medium,” or “fast.” As yet another example, syntax generators may be associated with an amount of time, such as the average amount of time it takes the syntax generator to run and produce a token set.

Various scores or properties of syntax generators may be stored in a syntax generator index associating the syntax generator models with corresponding scores or properties. For example, each model of the syntax generator module configured to generate textual syntax may be associated in the syntax generator index with a language property, a sophistication score, a realism score, a speed score, a model type, etc. The syntax generator index may be constructed to allow for efficient searching through the models to find a specific model that meets requirements from the request. As described below, the syntax generator index may be searched to identify a model that meets certain preferences or requirements. The syntax generator index may be stored by a component of environment 101, such as storage device 105, or additionally or alternatively, syntax generator module 107. The syntax generator index may also store content or token types associated with syntax generators. For example, a certain syntax generator may be configured to create token sets having tokens representing names, content or filler words, and account numbers. Accordingly, the syntax generator index may also associate the syntax generator with the three token types of names, content or filler words, and account numbers. As described below, this information may be used to select content generators corresponding to a syntax generator's associated token types. Consistent with disclosed embodiments, models (e.g., syntax generators) can be stored in a variety of suitable ways, for example, stored and hosted on a website or stored in the local filesystem or memory of a computer, or on storage device 105.

Syntax generators may be any of a variety of suitable data models for generating data or tokens. For example, a syntax generator may be one of a variety of machine learning model types, such as a generative adversarial network, neural network, recurrent neural network, kernel density estimator, long short-term memory network (LTSM), transformer, or other suitable machine learning or artificial intelligence model. Syntax generators may function as replaceable modules for generating synthetic data according to a particular syntax corresponding to the syntax generator. For example, a syntax generator may be configured to generate synthetic syntax for emails, while another syntax generator may be used for contracts and yet another for text messages. Syntax generators may be used in conjunction with content generators to produce synthetic data sets, as described herein. Syntax generators may be trained using training data sets and may be trained to generate tokens at a particular statistical rate or place certain tokens in a token set relative to other tokens.

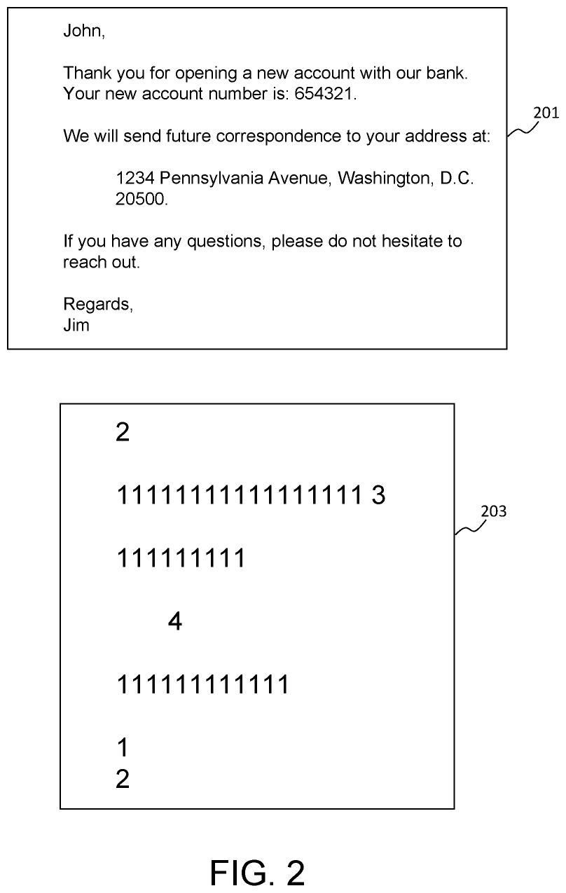

FIG. 2 is an illustration depicting an exemplary synthetic data syntax, consistent with disclosed embodiments. Email 201 depicts an exemplary email message. Email 201 may for example, be a sample message indicating the format of synthetic data to be generated. For example, in training a machine learning model to recognize malicious email messages, a large sample of synthetic emails may be desired to train the model. Email 201 may be tokenized as shown in tokenized email 203.

As depicted by tokenized email 203, specific tokens may be assigned to various types of information or words within an email. In tokenized email 203, the tokens are represented as single-digit numbers, but it is understood that tokens may take a variety of forms. In the example of tokenized email 203, the token 2 represents a name. Token 1 may represent a content text. For example, each 1 in tokenized email 203 may represent a filler word used to construct the body of the email. In some contexts, synthetic data that is agnostic to the actual content of the body of the email may be desired. In such a case, more filler content text word tokens may be used in the token set, in lieu of other more specific token types (such as names, addresses, verbs, account numbers, etc.). As an example embodiment, a user may desire synthetic emails and employ models that correctly format emails without regard to whether the content of the emails forms realistic sentences. In this example in which the desired synthetic data may be content agnostic, more filler content text tokens may be placed in the token set. In other contexts, the syntax generator may be configured to use additional tokens representing other specific types of words or information to provide additional context, or even realism, to the syntax (and eventually to the synthetic data generated using the syntax). Token sets may include tokens representing other information. For example, token 3 in FIG. 2 may represent an account number, while token 4 may represent an address.

Tokenized email 203 may be an example of syntax generator output. For example, a syntax generator configured to generate email messages may output a token set such as that depicted by tokenized email 203. Of course, tokenized email 203 is just one example of a token set that may be output by a syntax generator configured to generate email messages. While the general format may remain the same, the tokens and their relationships may vary. As an example, another tokenized email may not include an account number (token 3). Other tokenized emails may include additional tokens representing other information not depicted in FIG. 2. Yet further examples may include more or fewer filler words (token 1), providing a lengthier or shorter body to the email.

Referring back to FIG. 1, environment 101 may also include a content generator module 109. Content generator module 109 may be a storage device configured to store one or more content generators. Content generator module 109 may also store information related to various content generators, for example, indicating a type of content or token type corresponding to a particular content generator. As used herein, a content generator is a data model configured to generate content for synthetic data. Content for synthetic data may correspond to tokens within token sets created by a syntax generator. For example, content may be generated to take the place of a certain token in a syntax generator's token set. Content generators may be any of a variety of suitable data models for generating data content. For example, a content generator may be one of a variety of machine learning model types, such as a generative adversarial network, neural network, recurrent neural network, kernel density estimator, transformer, or other suitable machine learning or artificial intelligence model. In some embodiments, a content generator may be an existing language model, such as a deep learning language model, for example, OpenAi's GPT-2 or GPT-3, or Microsoft's Turing-NLG. In other embodiments, a content generator may be a specially designed model to generate specific data content, for example, a bank may develop a content generator for generating synthetic account numbers or customer identifiers according to a proprietary format.

Content generators may be configured to generate content for a particular content or token type. Thus, different content generators may be configured to generate different types of content corresponding to different tokens. Thus, content generators may be swapped out with various syntax generators, depending on the syntax generated and the particular synthetic data ultimately desired. Continuing the example of tokenized email 203 from FIG. 2, a content generator may be configured to generate first names (e.g., to provide content for token 2). Another content generator may be configured to generate filler words (e.g., to provide content for token 1). Such a filler word content generator may be able to generate more realistic synthetic data content by receiving as input, for example, the entire token set from the syntax generator, a total number of consecutive filler word tokens, previously generated filler words in preceding tokens in the token set, or other inputs that the content generator may use for context when generating new content. Other content generators may merely take as input a desired number of output pieces of data content. Continuing the example from FIG. 2, other content generators may be created to generate account number content (e.g., token 3) or addresses (e.g., token 4). As an example in this context, the address content generator may take the input of the number 1, indicating that there is only one token 4 in the token set. In some embodiments, as described below, a content generator may be executed multiple times to generate data content for multiple instances of a token in a token set.

Individual content generators may be trained to generate a variety of types of words or information, such as filler or content words, transition words, stop words, various parts of speech, names, addresses, numbers of varying formats (e.g., account numbers, social security numbers, phone numbers, etc.), dates, times, coordinates or other location information, and others. In some embodiments, content generators may be specific to a language or dialect. For example, a content generator may generate Spanish filler words. As another example, a content generator may generate words in American English, while yet another content generator may generate words in British English.

Similar to the syntax generator index described above, information related to content generators may be stored in a content generator index. The index may be stored by a component of environment 101, such as storage device 105, or additionally or alternatively, content generator module 109. The index may associate content generators with various properties, such as a content type that the generator is configured to produce, a language or dialect, an indication of realism of the produced content, a sophistication level of the produced, a model type, a model speed, or other suitable characteristic of the content generator model, its output, or the desired synthetic data ultimately to be produced using the content output. As an example, a content generator may be associated in the index with a content type such as filler or content words, transition words, stop words, various parts of speech, names, addresses, numbers of varying formats (e.g., account numbers, social security numbers, phone numbers, etc.), dates, times, coordinates or other location information, and others. As another example, a speed of the content generator may also be stored in the index, such as a scaled numerical score, a relative speed level, or an amount of time, such as the average amount of time it takes the syntax generator to run and produce a certain amount of content data, or any other representation of a rate or time to perform a task.

Syntax generators and content generators may be used in combination to produce synthetic data sets, as described herein. The data within produced synthetic data sets may have a particular form. As described above, a variety of forms are possible, including but not limited to documents (e.g., letters, contracts, patents, applications, data-entry forms, articles, transcripts, or others), digital communications (e.g., emails, text messages, messages from instant-messaging platforms or others), audio files (songs, voice messages, phone calls, etc.), images, video files, or other forms taken by various types of data. In some embodiments, one or more of these synthetic data forms may be combined. As an example, a text document may also include one or more embedded images. One of skill in the art would recognize that the embodiments may include still other examples of combined synthetic data forms.

Syntax generators and content generators may be used together as part of a modular data generation system. The modular data generation system disclosed may improve the speed and efficiency of synthetic data generation. For example, only one generator within a modular system may need to be trained to apply the system to generate synthetic data of a new format. This may result in less consumption of time and computing resources. A modular data generation system may also facilitate tighter security and privacy controls over sensitive data for which synthetic data is to be generated. The modular system may allow a user to receive a trained syntax generator replicating the syntax of sensitive data without ever accessing the sensitive data. The user may implement the syntax generator in concert with the user's content generators and thereby create synthetic data related to the sensitive data. A syntax generator may be used to generate syntax (i.e., a token set) corresponding to a particular form of synthetic data. One or more content generators may then be used to generate data content (i.e., words, phrases, numbers, or other information) corresponding to the various tokens within the token set. Content generators may be executed multiple times to generate multiple pieces of data content for a particular token type. These pieces of data content may be used to fill in different instances of particular tokens in a token set. In some embodiments, multiple pieces of data content may be used to create multiple pieces of synthetic data based on one syntax-token set. Similarly, disclosed embodiments may include executing the syntax generator multiple times to create multiple syntax-token sets. The token sets may be similar (to the extent needed to maintain a certain format for the synthetic data) but may vary from set to set.

In the example of FIG. 2, a syntax generator may generate tokenized email 203. In a subsequent execution of the syntax generator, a different token set representing email syntax may be generated. The second token set might, for example, include more or fewer filler word tokens 1. The second token set also may not include an address token 4 and might instead include token 5 representing a date or other type of information.

As another example based on the illustration of FIG. 2, a syntax generator and multiple corresponding content generators may be developed and trained using data related to the United States. Accordingly, a content generator for generating addresses (e.g., for token 4) may be configured to generate U.S. addresses. These models may be used by an entity (e.g., a user or an organization) that wishes to also use the models in the United Kingdom. Thus, given the modularity of the disclosed embodiments, in order to use the models to generate synthetic data having addresses in UK format, only the one content generator need be replaced. Rather than retrain an entire new model to generate synthetic emails (a task which may be time and resource intensive) the entity needs to only develop (or retrieve from storage) a content generator for generating UK addresses. Further, once such a UK address content generator is developed, it may be used in conjunction with a variety of syntax generators to create synthetic data having a variety of different formats and characteristics.

Thus, by enabling the modular interchangeability of syntax and content generators, disclosed embodiments may significantly decrease the time, resources, and costs associated with generating synthetic data sets. By using modular generators dedicated to syntax and content, generators may be used across multiple problem domains. Accordingly, a smaller (e.g., a less complex, less computationally expensive, or faster) model may be generated for new types of synthetic datasets. For example, new forms of synthetic data may be generated training a syntax generator for the desired forms. Then, existing content generators may be used to generate content for token sets generated by the syntax generator. Such modularity may save significant time and resources because rather than train a very large model to generate the form and content of the synthetic data sets, only a smaller syntax model needs to be trained.

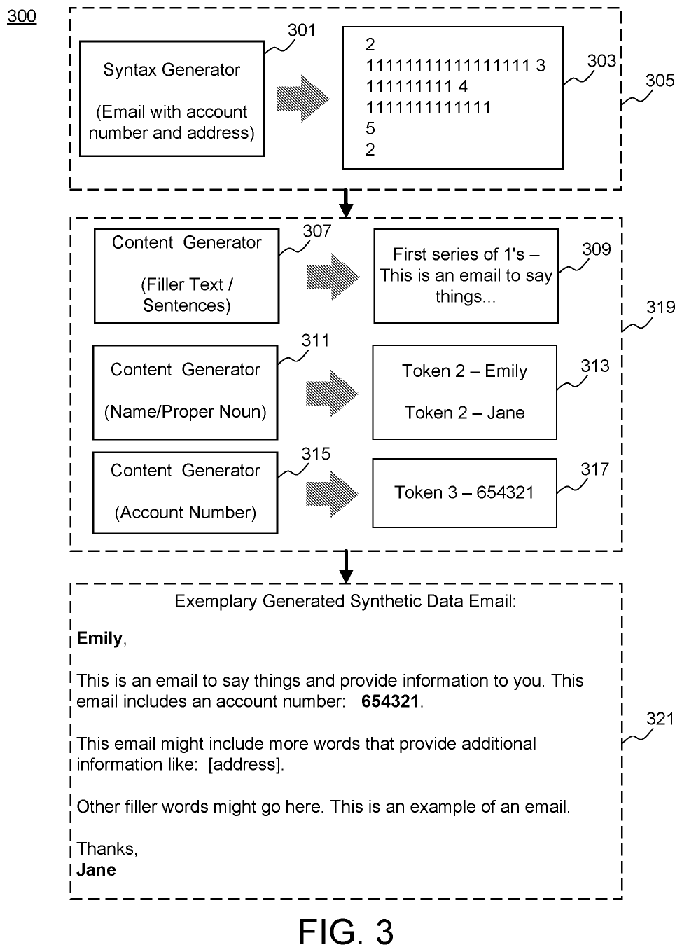

FIG. 3 is a block diagram depicting an exemplary process 300 for generating synthetic data using a modular syntactic generator, consistent with disclosed embodiments. Process 300 may be executed by, for example, computing resource 103, in conjunction with storage device 105, syntax generator module 107, and content generator module 109. For example, computing resource 103 may retrieve syntax generator 301 from syntax generator module 107. Similarity, computing resource 103 may retrieve content generators 307, 311, 315 from content generator module 109. In some embodiments, information stored by storage device 105 may indicate to computing resource 103 which particular generators computing resource 103 should retrieve from syntax generator module 107 and content generator module 109.

At step 305, process 300 may include implementing syntax generator 301 to generate token set 303. Syntax generator 301 may be configured to generate syntax-token sets corresponding to emails, for example. In some embodiments, syntax generator 301 may be even more specialized. As an example, syntax generator 301 may be configured to generate syntax for emails that contain both an account number and an address in the body of the email. Syntax generator 301 may be configured to generate token sets in various formats, based on information received in a request or as a command, for example. In some examples, step 305 includes analyzing a data set to identify a data format for a token set to be generated. For example, a request for synthetic data may include a reference email, and the system may analyze the reference email to identify data types included in the reference email, such as an address, an account number, or filler content. Process 300 may include receiving instructions specifying a data format of a desired token set, including one or more specified data types. Instructions may be received via a user interface and/or as part of a request for synthetic data. Syntax generator 301 may generate a token set that matches specified or identified data types according to a data format. For example, syntax generator 301 may be executed to return one or more token sets corresponding to an email. Token set 303 may correspond to, for example, tokenized email 203 of FIG. 2. As described above, token set 303 may contain a variety of different tokens corresponding to different types of information, such as names, filler text, addresses, account numbers, salutations, etc.

At step 319, process 300 may include implementing various content generators 307, 311, 315 to produce data content corresponding to the tokens of token set 303. For example, content generator 307 may be trained to generate content text. The content text may correspond to the 1 tokens of token set 303. In some embodiments, content generator 307 may generate data content based on the number of consecutive content text 1 tokens in a portion of token set 303, or based on surrounding token types. Accordingly, content generator 307 may generate a sentence or phrase to replace the 1 tokens in token set 303. For example, content generator 307 may output a series of content words 309 of “This is an email to say things” corresponding to the first seven instances of token 1 in token set 303.

Similarly, content generator 311 may be trained to generate names. The names may correspond to name tokens (i.e., token 2) of token set 303. Content generator 311 may generate a name for each instance of token 2 in token set 303. For example, content generator 311 may generate two names 313 (one for each token 2), such as Emily and Jane.

Content generator 315 may be trained to generate account numbers. The account numbers may correspond to account number tokens (i.e., token 3) of token set 303. Content generator 315 may generate an account number for each instance of token 3 in token set 303. For example, content generator 311 may generate account number 317, 654321. Content generator 315 may be trained to generate account numbers having a particular format or number of digits, as described above. For example, in the example of FIG. 3, content generator 315 may be configured to generate account numbers having six numerical digits. By contrast, other content generators may be configured to generate account numbers having more or fewer digits, alpha-numeric strings, dashes, colons, etc. according to a standard or proprietary format.

After syntax-token set 303 and content 309, 313, 317 is generated, process 300 may proceed to step 321. Step 321 may include generating synthetic data using token set 303 and content 309, 313, 317. Synthetic data may be generated by replacing tokens in token set 303 with content generated 309, 313, 317 at step 319 by content generators 307, 311, 315. For example, the first instance of token 2 in token set 303 may be replaced with “Emily” from content 313. Likewise, the second instance of token 2 in token set 303 may be replaced with “Jane” from content 313. Similarly, token 3 in token set 303 may be replaced with account number content 317 (“654321”). Accordingly, the resulting synthetic data piece may take the form of email 321 depicted in FIG. 3.

FIG. 4 is a flowchart depicting an exemplary process 400 for generating synthetic data using a modular syntactic generator, consistent with disclosed embodiments. Process 400 may be executed by, for example, computing resource 103, in conjunction with storage device 105, syntax generator module 107, and content generator module 109. For example, computing resource 103 may retrieve syntax generator 301 from syntax generator module 107. Similarity, computing resource 103 may retrieve content generators 307, 311, 315 from content generator module 109. In some embodiments, information stored by storage device 105 may indicate to computing resource 103 which particular generators computing resource 103 should retrieve from syntax generator module 107 and content generator module 109. Steps of process 400 may include processes described in reference to FIG. 3 and process 300.

At step 401, process 400 may include receiving a request for synthetic data. A request for synthetic data may be received from for example, a computing device associated with a user or through an interface provided to a user. In some embodiments, the request may be received from another computing resource, for example a device or virtual instance training a model and requiring synthetic data for the training. The request may indicate a synthetic data format. For example, the request may include instructions specifying a synthetic data format. Additionally or alternatively, the request may include an example data (e.g,. an email) containing data types and process 400 may include analyzing the example data to determine a data format. The synthetic data format may be related to, for example, the type of desired data or the type of model the data may be used to train.

As described herein, synthetic data may take a variety of formats. For example, a synthetic data format may be a text-based format. Text-based formats include, but are not limited to, documents, forms, written communications, articles, and the like. In some embodiments, a synthetic data format may indicate a document type, such as a contract, email, patent, application, etc. Disclosed embodiments are not limited to text-based formats of synthetic data. For example, synthetic data formats may be audio, image, or video formats.

At step 403, process 400 may include selecting, based on the synthetic data format, a first syntax generator. A syntax generator may be selected from, for example, syntax generator module 107. As described above, syntax generator module 107 may store a variety of syntax generator models. The syntax generator models may each be trained to generate a specific syntax for a certain data format (e.g., emails, documents, images, etc.). Accordingly, a specific syntax generator model may be selected based on the desired format of the synthetic data ultimately to be produced.

A syntax generator may be selected in a variety of ways. For example, selecting a syntax generator may be based on a property of the desired synthetic data. The request may indicate a property of the desired synthetic data upon which the syntax generator may be selected. A property of the desired synthetic data may include a format or type of data, a desired language, an indication of realism of the desired data, a sophistication level of the synthetic data, a sentiment of the synthetic data (e.g., a level or indication of attitude or emotion), or other suitable characteristic of the desired synthetic data.

As an example, if the request indicates that the desired data format is an email, a syntax generator for generating email syntax may be selected. As another example, if a request indicates that the desired data format is a contract, a generator for generating contract syntax may be selected. In some embodiments, syntax generators may be language specific.

Selecting a syntax generator based on a property of the desired synthetic data may permit a certain level of user customization of the generated synthetic data. This example may also provide increased efficiency and speed by obviating a need to develop and train a specific synthetic data model. Instead, the system or a user may select a model that is already trained and, for example, apply newly developed content generators.

A request may express a property of the desired synthetic data as a criterion, such as a language criterion. A language criterion may indicate a desired language of the output synthetic data. A request for synthetic data may indicate a desired language (e.g., English, French, Spanish, Portuguese, or others), which could be used to select the syntax generator. In some embodiments, a language criterion may include a certain dialect or other regional variation of a language. Syntax generators may be trained to generate syntax based on a specific language or dialect. As an example, various syntax generators may be configured to generate syntax for a sentence. Accordingly, the tokens within the token sets produced by such syntax generators may relate to, for example, certain parts of speech (e.g., noun, verbs, adjectives, adverbs, conjunctions, etc.). In such a case, the sentence syntax may be language specific. For example, English and Spanish may have different placement of articles and adjectives, requiring different orders of the corresponding tokens in a token set to generate realistic sentences. Accordingly, various sentence syntax generators may be trained and stored in syntax generator module 107. For example, one syntax generator may correspond to English sentences while another may correspond to Spanish sentences. Accordingly, selecting a syntax generator may be based on a language criterion.

A request may include other types of syntax generator criteria, such as a realism criterion, a speed criterion, or a sophistication criterion. Syntax generator criteria may be evaluated against scores associated with individual syntax generators. Syntax generators may be associated with scores corresponding to one or more criteria. For example, a syntax generator may be associated with one or more of a realism score, a speed score, or a sophistication score. A realism score may be based on one or more realism factors, as disclosed in greater detail below. A speed score may indicate the relative speed of execution of the syntax generator model or its model type, as compared to other models or model types. Scores may take the form of a numerical scale (e.g., 1-10 or 1-100), a percentage, a relative level (e.g., low, medium, high), or other suitable form for comparing models.

Various scores or properties of syntax generators may be stored in an index associating the models with corresponding scores or properties. For example, each model of the syntax generator module configured to generate textual syntax may be associated in the index with a language property, a sophistication score, a realism score, a speed score, etc. The index may be constructed to allow for efficient searching through the models to find a specific model that meets requirements from the request. For example, a request may indicate that synthetic data be in the form of a sentence, be in the English language, and be generated by a high-speed model (e.g., a model with a speed score of at least 7 on a 1-10 scale). Accordingly, the system may select a model by searching the index for a model that meets these requirements. As described above, the index may be stored by storage device 105, or additionally or alternatively, stored by syntax generator module 107.

According to disclosed embodiments, a syntax generator may be selected based on a desired type of model of the syntax generator. For example, the request may indicate that a certain type of model is desired, such as a Generative Adversarial Network (“GAN”). Accordingly, a syntax generator that is a GAN may be selected. A syntax generator may be associated with a model type in the syntax generator index, as described herein. As another example, a request may indicate that a model of relatively high speed is desired or that a model having certain characteristics is desired (e.g., a recurrent neural network having a certain number of layers). Accordingly, a syntax generator may be selected by automated searching of the syntax generator index for syntax generators associated with the desired model type, speed, or characteristics.

At step 405, process 400 may include generating, using the first syntax generator, a token set. As described above, a token set may comprise one or more tokens. Tokens may correspond to various types of words or information. Accordingly tokens may have a corresponding token type that indicates the type of word or information that the token represents. For example, a token may have a type corresponding to a filler word, a name, address, account number, social security number, part of speech, color, sound, image, or word or information type. The token type may be based on a data type and/or data format identified at step 403.

At step 407, process 400 may include identifying token types corresponding to the tokens within the token set. As described herein, tokens within a token set may be of different types. Accordingly, a token type of a first token may differ from a token type of a second token. Identifying token types may permit selection of content generators associated with the identified token types. Thus, content generators that are not previously associated with a specific syntax generator may be selected to produce content data for the syntax generator's token set. Such selection of content generators based on token type enables the modular interchange of syntax and content generators to generate synthetic data without the need of prior association of the content generators with a given syntax generator.

In some embodiments, token types may be identified by accessing the syntax generator index and determining the token types associated with a selected syntax generator in the syntax generator index.

Additionally, or alternatively, token types may be identified based on token properties. For example, tokens may have associated properties that indicate a corresponding type of content. In some embodiments, syntax generator index or content generator index may individually map tokens to a token type. Accordingly, identifying a token type may include accessing an index and determining the token type associated with the token in the index.

At step 409, process 400 may include selecting one or more content generators. The content generators may be selected from content generator module 109. As described herein, content generator module 109 may contain a variety of content generators configured to generate various forms of content data to fill in syntax-token sets produced by syntax generators. The content generators may be associated with a specific content type. Accordingly, content generators corresponding to the token types of the tokens within the generated token set may be selected. A content generator may be selected for each unique token type present within a given token set.

As described above, information related to content generators may be stored in a content generator index. The index may be stored by a component of environment 101, such as storage device 105 or content generator module 109. The index may associate content generators with various properties, such as a content type that the generator is configured to produce, a language or dialect, an indication of realism of the produced content, a sophistication level of the produced, a model type, a model speed, model characteristics, token type, desired synthetic data type, or other suitable characteristic of the content generator model, its output, or the desired synthetic data. As an example, a content generator may be associated in the index with a content type such as filler or content words, transition words, stop words, various parts of speech, names, addresses, numbers of varying formats (e.g., account numbers, social security numbers, phone numbers, etc.), dates, times, coordinates or other location information, and others. As another example, a speed of the content generator may also be stored in the index, such as a scaled numerical score, a relative speed level, or an amount of time, such as the average amount of time it takes the syntax generator to run and produce a certain amount of content data. As yet another example, content generators may be associated with model characteristics, such as a number of layers or certain hyperparameters. As described below, content generators may be selected by searching the content generator index to determine one or more content generators that are associated with certain tokens, token types, scores, or other properties.

According to disclosed embodiments, tokens may be mapped directly to content generators in content generator index. For example, content generators may be mapped directly to certain tokens. Accordingly, selecting a content generator may include searching the index for a content generator associated with a certain token.

Alternatively or additionally, content generators may be selected based on the selected syntax generator. For example, syntax generators may correspond to certain token types (i.e., the types of tokens that they use to generate token sets). Such information may be stored within, for example, a syntax generator index or content generator index. Accordingly, step 409 may include accessing an index to retrieve information indicative of the token types associated with a syntax generator and selecting content generators corresponding to those associated token types. In some embodiments, the content generator may be selected based on the synthetic data format. The synthetic data format may correspond to certain types of tokens. For example, an email data format may correspond to name, content or filler word, and salutation tokens. As another example, a sentence data format may correspond to tokens associated with the various parts of speech.

According to disclosed embodiments, selecting a content generator may be based on a criterion. Content generator criteria may be evaluated against scores or properties associated with individual content generators. As described above content generators may be associated with scores or properties in a content generator index. For example, a syntax generator may be associated with one or more of a realism score, a speed score, or a sophistication score. A realism score may be based on one or more realism factors, as described in greater detail below. A speed score may indicate the relative speed of execution of the content generator model or its model type, as compared to other models or model types. Scores may take the form of a numerical scale (e.g., 1-10 or 1-100), a percentage, a relative level (e.g., low, medium, high), or other suitable form for comparing models. A request may include indicators of one or more content generator criteria, such as a realism criterion, a speed criterion, a sophistication criterion, etc. These criteria may be evaluated against the scores and properties associated with various content generators, for example, by searching the content generator index for suitable content generators having the desired scores or properties.

Various criterion for selecting content generators may be used, such as a realism criterion or a language criterion. In some cases, certain content generators may produce more realistic data content than others. For example, a content generator for content or filler words may not consider context of any of the filler words generated and may result in less realistic data content. However, other content generators may be more sophisticated and considered more context when generating data content. While such generators may be slower and more computationally expensive, they may result in more realistic content. Accordingly, a realism criterion may indicate a relative level of realism desired in the resulting synthetic data, and a content generator may be selected accordingly. In some embodiments, a realism score may be based on one or more realism factors, such as compliance of the writing with grammatical rules or standards, a semantic context, the presence or absence of colloquialisms or slang or profanity, prevalence of colloquialisms or slang or profanity, average word size (e.g., the average number of letters of the words within the text), average sentence length, characteristics of punctuation, paragraph structure, sentence structure, general purpose of a text (e.g., whether the text is written for persuasion, historical account, explanation, technical explanation, communication, etc.), or any other factor that reflects a degree to which synthetic data resembles real data. In some examples, a realism score may be an aggregate of scores associated with respective realism factors. Alternatively or additionally, a realism score may be generated by a machine learning model trained to identify realistic content (e.g., a model trained under human supervision). In some embodiments, an additional model may be used to “proofread” generated synthetic data and make suggestions to improve the realism of the data. For example, generated synthetic data could be fed into another model that determines a level of realism of the data and then outputs suggestions to increase the level of realism. In some embodiments, this may include identifying errors in content, grammar, syntax, etc. of the generated synthetic data. Based on such identifications, the content generator may then be refined (e.g., through adjusting weights or layers of the model) to increase the level of realism of the synthetic data output.

As described above, synthetic data may be generated that includes text of different languages. Accordingly, a language criterion (e.g., as indicated by the request for synthetic data) may indicate a desired language of the synthetic data. Content generators producing content data in the desired language may then be selected. As described above, a generator may be selected by searching the content generator index for suitable content generators being associated with the desired language.

Content generators may also be selected based on a model type or speed criterion. For example, the request may indicate that a certain model type is desired (e.g., a generative adversarial network). As another example, a request may indicate that a model of relatively high speed is desired or that a model having certain characteristics is desired (e.g., a recurrent neural network having a certain number of layers). Accordingly, a content generator may be selected by searching the content generator index for suitable content generators being associated with the desired model type, speed, or characteristics.

Step 411 of process 400 may include generating data content. The selected content generators may be executed to generate data content corresponding to tokens of the token set generated by the syntax generator at step 405. As described herein, each selected content generator may generate data content corresponding to a different token type of the token set.

At step 413, process 400 may include generating a synthetic data set. The synthetic data set may be generated by replacing, in the token set, the token with the corresponding content data generated at step 411. For example, as explained with regard to the illustration of FIG. 3, the first instance of token 2 in token set 303 may be replaced with “Emily” from content 313. Likewise, the second instance of token 2 in token set 303 may be replaced with “Jane” from content 313. Similarly, token 3 in token set 303 may be replaced with account number content 317 (“654321”). The instances of token 1 may be replaced with content text data of content 309. Accordingly, the resulting synthetic data piece may take the form of email 321 depicted in FIG. 3.

In some embodiments, process 400 may be implemented to generate a plurality of synthetic data records. As used herein, a synthetic data record may refer to a portion of synthetic data that is part of a larger synthetic dataset. As an example, a single synthetic email of a larger synthetic data set including a plurality of synthetic emails may be a synthetic data record. To generate a plurality of data records, steps 411 and 413 may be repeated to generate new data content and replace the tokens of another instance of the token set to create a new synthetic data set. According to disclosed embodiments, one or more of steps 405 through 409 may also be repeated, for example, to generate a new token set that may be used to generate additional synthetic data records. Generating similar synthetic data sets from multiple different token sets may add variety to the generated synthetic data, which may be desirable, for example, for training certain machine learning models.

Consistent with disclosed embodiments, the plurality of generated synthetic data records may be used as training data. Such training data may be used to train a machine learning model.

According to disclosed embodiments, different syntax generators may be used to generate synthetic data sets with different formats. For example, process 400 may include receiving a second request for synthetic data. The second request for synthetic data may indicate a synthetic data format, as described above. For example, the request may provide an indication that the synthetic data is to take the form of a sentence, paragraph, email, letter, contract, or other form of synthetic data, as described herein. The synthetic data format of the second request may be different from the first synthetic data format of the first request. For example, the first synthetic data format may be an email and the second synthetic data format may be a contract. The different formats may require different syntax generators, but might actually include one or more of the same token types. For example, an email and a contract may both include content text words (e.g., token 1 from the figure examples) and names (e.g., token 2 from the figure examples).

Then, process 400 may include selecting, based on the second synthetic data format, a second syntax generator. The second syntax generator may be different from the first syntax generator selected at step 403. Selecting the second syntax generator may occur substantially as described with respect to selecting the first syntax generator at step 403. Process 400 may also include generating, using the second syntax generator, a second token set. Generating the second token set may occur substantially as described with respect to generating the first token set at step 405. The second syntax-token set may be different from the first token set generated by the first token generated at step 405. The second token may include different token types or one or more of the same token types as the first token set. For example, the second token set may include the first token and the second token with the same types as the first token set, even though it was generated using a different syntax generator. As another example, the second token set may also include a third token having a third token type. Such a third token type may not be included in the first token set.

Inclusion of the same token types in different token sets may permit, for example, usage of one or more of the same content generators to generate data content. Disclosed embodiments may thereby increase the efficiency and versatility of synthetic data generation. Accordingly, token types may be identified and content generators may be selected and used to generate data content, as described above with respect to steps 407-411. In some embodiments, process 400 may include generating a second synthetic data set by replacing, in the second token set, the first and second tokens with generated content data. with the first content data and the second token with the second content data. In cases where the second token set includes a third token type, a content generator associated with the third token type may be selected and used to generate third content data. The third content data may replace the third token when generating the synthetic data set.

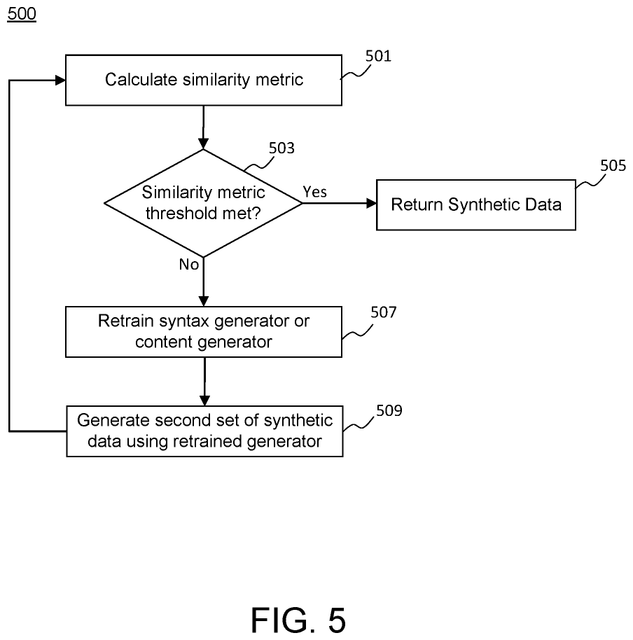

FIG. 5 is a flowchart depicting an exemplary process 500 for provisioning modular generators, consistent with disclosed embodiments. Process 500 may be executed by, for example, computing resource 103, in conjunction with storage device 105, syntax generator module 107, and content generator module 109. Process 500 may be used to provision and refine syntax generators and content generators. For example, process 500 may be used to train and refine generators to produce synthetic data that falls within a certain range of relative similarity to a reference data set, according to a calculated similarity metric. In some cases, there may be a range of acceptable similarity metrics to the reference data set for new synthetic data. For example, generated synthetic data that is identical or nearly identical to a reference data set may not be useful for training other models because it may not have sufficient variation from the reference data set to meaningfully train the model. However, synthetic data that falls below a threshold of similarity may also not be useful in some cases. For example, if the reference data set is an email, but the generated synthetic data does not resemble an email, the synthetic data may not be useful for, as an example, training another model using synthetic emails.

Accordingly, a similarity metric may be calculated and evaluated for a synthetic data set generated during process 400, for example. Step 501 of process 500 may include calculating a similarity metric. The similarity metric may reflect a measure of similarity between the synthetic data set and reference data. Reference data may be, for example, data associated with a request for synthetic data. For example, a request for synthetic data may include the reference data or may include an indication of reference data that may be retrieved. Consistent with disclosed embodiments, step 501 may include retrieving the reference data based on a request. Reference data may be retrieved from, for example, storage device 105. An indication of reference data may be used to retrieve the proper reference data. As an example, computing resource 103 executing process 500 may forward the indication of reference data to storage device 105 or otherwise use the indication of reference data to retrieve the reference data.

A similarity metric may be in a variety of suitable forms. For example, a similarity metric may be a numerical score, percentage, relative level (e.g., highly similar, moderately similar, or not similar), or other reference evaluation indicating a degree of similarity between generated synthetic data and reference data.

Step 501 may also include identifying a similarity threshold. The threshold may indicate whether synthetic data is too similar to reference data or is insufficiently similar to reference data. Accordingly, in some embodiments, a similarity threshold may include two parts (e.g., a high value and a low value). For example, if the similarity metric is above the high value, the data may be too similar. Likewise, if the similarity metric falls below the low value, the data may not be similar enough.

At step 503, process 500 may include determining whether the similarity metric meets a similarity threshold. If the similarity metric meets the threshold (e.g., is not too similar or not too dissimilar), process 500 may proceed step 505 and return the generated synthetic data without refining any of the models. If the similarity metric fails to meet the threshold (e.g., the synthetic data is either too similar or too dissimilar to the reference data), process 500 may proceed to step 507. At step 507, process 500 may include retraining one or more of a syntax generator or content generator used to generate the synthetic data. For example, if data are not similar enough, process 500 may include retraining or refining the syntax generator used to generate the syntax-token set for the synthetic data. Retraining or refining may include adjusting parameter values, adjusting a number of layers, changing a model type, adjusting model weights, or making other suitable changes to a model. At step 509, process 500 may include using the retrained generator or generators to generate a second set of synthetic data. In some embodiments, process 500 may then proceed back to step 501, where it may include calculating a similarity metric for the second set of synthetic data, as described above.

Another aspect of the disclosure is directed to a non-transitory computer-readable medium storing instructions that, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage unit or the memory module having the computer instructions stored thereon, as disclosed. In some embodiments, the computer-readable medium may be a disc or a flash drive having the computer instructions stored thereon.

As used herein, the indefinite articles “a” and “an” mean “one or more” unless it is unambiguous in the given context. Similarly, the use of a plural term does not necessarily denote a plurality unless it is unambiguous in the given context. As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

It will be apparent to those skilled in the art that various modifications and variations can be made to the disclosed system and related methods. Other embodiments will be apparent to those skilled in the art from consideration of the specification and practice of the disclosed system and related methods. It is intended that the specification and examples be considered as exemplary only, with a true scope being indicated by the following claims and their equivalents.

What is claimed is:

1. A system for generating synthetic data, comprising:
at least one memory storing instructions; and
at least one processor configured to execute the instructions to perform operations comprising:
receiving a request for synthetic data, the request indicating a synthetic data format;
selecting, based on the synthetic data format, a first syntax generator;
generating, using the first syntax generator, a token set comprising a first token and a second token;
identifying a first token type corresponding to the first token and a second token type corresponding to the second token;
selecting, from a plurality of content generators, a first content generator associated with the first token type and a second content generator associated with the second token type;
generating, using the first content generator, first content data;
generating, using the second content generator, second content data; and
generating a first synthetic data set by replacing, in the token set, the first token with the first content data and the second token with the second content data.

2. The system of claim 1, wherein selecting the first content generator is based on a criterion.

3. The system of claim 1, wherein selecting the first content generator is based on the synthetic data format.

4. The system of claim 1, wherein selecting the first content generator is based on a language criterion.

5. The system of claim 1, wherein selecting the first syntax generator is further based on a language criterion.

6. The system of claim 1, wherein the synthetic data format is a text-based format.

7. The system of claim 1, wherein the synthetic data format is an image format.

8. The system of claim 1, wherein the operations further comprise:
calculating a similarity metric reflecting a measure of similarity between the synthetic data set and reference data; and
retraining, based on the similarity metric and a threshold, at least one of the first content generator or second content generator.

9. The system of claim 8, wherein the operations further comprise generating, based on the retrained content generator, a second set of synthetic data.

10. The system of claim 1, wherein the synthetic data format is an audio format.

11. A method for generating synthetic data, comprising:
receiving a request for synthetic data, the request indicating a synthetic data format;
selecting, based on the synthetic data format, a first syntax generator;
generating, using the first syntax generator, a token set comprising a first token and a second token;
identifying a first token type corresponding to the first token and a second token type corresponding to the second token;
selecting, from a plurality of content generators, a first content generator corresponding to the first token type and a second content generator corresponding to the second token type;
generating, using the first content generator, first content data corresponding to the first token;
generating, using the second content generator, second content data corresponding to the second token;
generating synthetic data by replacing, in the token set, the first token with the first content data and the second token with the second content data.

12. The method of claim 11, wherein the first token type is different from the second token type.

13. The method of claim 11, wherein the synthetic data format is a document type.

14. The method of claim 11, wherein the synthetic data format is a video format.

15. The method of claim 11, further comprising:
generating a plurality of synthetic data records by repeating the steps of:
generating, using the first content generator, first content data corresponding to the first token;
generating, using the second content generator, second content data corresponding to the second token; and
generating synthetic data by replacing, in the token set, the first token with the first content data and the second token with the second content data.

16. The method of claim 15, further comprising:
training a machine learning model by using the plurality of generated synthetic data records as training data.

17. The method of claim 11, further comprising:
receiving a second request for synthetic data, the request indicating a second synthetic data format different from the first synthetic data format;
selecting, based on the second synthetic data format, a second syntax generator, the second syntax generator being different from the first syntax generator;
generating, using the second syntax generator, a second token set different from the first token set and comprising the first token and the second token; and
generating second synthetic data by replacing, in the second token set, the first token with the first content data and the second token with the second content data.

18. The method of claim 17, wherein the second token set further comprises a third token having a third token type.

19. The method of claim 18, further comprising:
selecting, from the plurality of content generators, a third content generator associated with the third token type;
generating, using the third content generator, third content data; and
wherein generating the second synthetic data set further comprises replacing the third token with the third content data.

20. A method for generating synthetic data, comprising:
receiving a request for synthetic data, the request indicating a synthetic data format;
identifying a set of training data, the training data having the synthetic data format;
training, using the training data, a syntax generator to generate a plurality of tokens corresponding to the synthetic data format;
generating, using the syntax generator, a token set comprising a first token and a second token;
identifying a first token type corresponding to the first token and a second token type corresponding to the second token;
selecting, from a plurality of content generators, a first content generator corresponding to the first token type and a second content generator corresponding to the second token type;
generating, using the first content generator, first content data corresponding to the first token;
generating, using the second content generator, second content data corresponding to the second token;
generating synthetic data by replacing, in the token set, the first token with the first content data and the second token with the second content data;
calculating a similarity metric of the synthetic data by comparing the synthetic data to reference data;
determining that the similarity metric does not exceed a similarity threshold; and
retraining, based on the determination, the syntax generator.
